(19) United States
(12) Patent Application Publication
(10) Pub. No.: US 2023/0016436 A1
(43) Pub. Date: Jan. 19, 2023

(54) REINFORCING STRUCTURE FOR A WIND TURBINE BLADE

(71) Applicants: LM WIND POWER A/S, Kolding (DK); BLADE DYNAMICS LIMITED, Eastleigh Hampshire (GB)

(72) Inventors: Klavs JESPERSEN, Kolding (DK); Rama RAZEGHI, Eastleigh Hampshire (GB); Dylan REDMOND-GRAY, Eastleigh Hampshire (GB)

(21) Appl. No.: 17/786,055

(22) PCT Filed: Apr. 15, 2020
(86) PCT No.: PCT/EP2020/060552

§ 371 Date: Jun. 16, 2022

(51) Int. Cl. F03D 1/06; B29C 70/34; B29C 70/88

(52) U.S. Cl. CPC F03D 1/0675; B29C 70/345; B29C 70/882; F05B 2280/6003; B29K 2307/04

(57) ABSTRACT

The present invention relates to a reinforcing structure, such as a reinforcing structure for reinforcing a wind turbine blade, comprising: a first composite element layer comprising at least two carbon fibre reinforced composite elements; a second composite element layer comprising one or more carbon fibre reinforced composite elements; an interlayer sandwiched at least partly between the first and the second composite element layer, the interlayer comprising an electrically conductive portion and a non-conductive portion surrounding the conductive portion, the conductive portion abutting exactly two of the carbon fibre reinforced composite elements comprised in the first composite element layer. A method for manufacturing such a structure is also provided.

### FIELD OF THE INVENTION

The present invention relates to a reinforcing structure for a wind turbine blade and to a wind turbine blade reinforced with such a reinforcing structure.

### BACKGROUND OF THE INVENTION

Wind power is a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 90 meters in length.

Wind turbine blades are usually manufactured by forming two shell parts or shell halves from layers of woven fabric or fibre and resin. Spar caps or main laminates are placed or integrated in the shell halves and may be combined with shear webs or spar beams to form structural support members. Spar caps or main laminates may be joined to, or integrated within, the inside of the halves of the shell.

As the size of wind turbine blades increases, various challenges arise from such blades being subject to increased forces during operation, requiring improved reinforcing structures. The manufacturing of large reinforcing structures, such as spar caps or spar beams, is likewise challenging, in particular when pultruded carbon fibre reinforced composite spar caps are used as the reinforcing members. Carbon fibres are typically lighter than glass fibres by volume. Carbon pultrusion lay-up thus often results in slight overlap and/or misplacement of carbon pultrusion layers, which may introduce gaps. Further, pultrusions do not line up completely, and thus gaps between individual pultrusions is a problem.

Gaps between carbon fibre reinforced composite pultrusions make the structure susceptible to flashover between pultrusions in case lightning strikes the blade and a current rushes through the blade. Such flashovers can be detrimental to the mechanical integrity of the blade.

It is therefore an object of the present invention to provide a reinforcing structure for a wind turbine blade, where the risk of flashover within the reinforcing structure is reduced or even eliminated.

### SUMMARY OF THE INVENTION

The present invention provides a reinforcing structure for a wind turbine blade, where the risk of internal flashover as a result of a lightning strike is mitigated or even eliminated.

In a first aspect, the invention provides a reinforcing structure comprising:
a first composite element layer comprising at least two carbon fibre reinforced composite elements,
a second composite element layer comprising one or more carbon fibre reinforced composite elements,
an interlayer sandwiched at least partly between the first and the second composite element layer, the interlayer comprising an electrically conductive portion and a non-conductive portion surrounding the conductive portion, the conductive portion abutting exactly two of the carbon fibre reinforced composite elements comprised in the first composite element layer.

The reinforcing structure may for instance be a structure for reinforcing a wind turbine blade.

In the reinforcing structure, two carbon fibre reinforced composite elements in the first composite element layer are in electrical connection via the conduction portion. This reduces or eliminates the problem of flashover occurring within the reinforcing structure during a lightning strike.

It is important that the conductive portion does not extend throughout an interlayer, but only contacts two carbon fibre reinforced composite elements in a layer, and preferably extends only enough to establish the desired conductance between those two elements. The reason is that the conductive portions may comprise a material that is not easily permeable to liquid resin. It can therefore be difficult during an infusion process for creating a composite reinforcing structure to force the liquid resin into all voids between the carbon fibre reinforced composite elements, especially near the conductive portions. By reducing the extent of conductive portions, this problem is reduced. However, the dimensions of the conductive portion should not be so small that the conductance is insufficient to prevent flashover. The person skilled in the art will, with the knowledge provided in this specification, recognize that this is a matter of design and that the size of the conductive portion depends for instance on the electrical resistivity of the material or materials chosen for the conductive portion. A higher resistivity will require a larger conductive portion to achieve sufficient conductance.

One or more, such as all, of the carbon fibre reinforced composite elements have a fibre content of at least 50%, such as at least 60%, such as at least 65%, determined by weight % or by volume %.

One or more, such as all, of the carbon fibre reinforced composite element may comprise materials other than carbon, such as glass, such as glass fibres.

In some embodiments, a conductivity of the conductive portion is at least 0.03 S/m, such at least 0.0375 S/m, such as at least 0.05 S/m, such as at least 0.1 S/m.

In some embodiments, the conductive portion further abuts exactly two carbon fibre reinforced composite elements comprised in the second composite element layer. In this way, a conductive portion provides electrical contact between four carbon fibre reinforced composite elements. Such embodiments may further reduce the risk of flashover.

In some embodiments, the conductive portion abuts exactly two of the carbon fibre reinforced composite elements comprised in the first composite element layer and abuts exactly one carbon fibre reinforced composite element comprised in the second composite element layer. This may be the case in a part of a reinforcing structure where one element, not two or more, in the second composite element layer overlaps with two elements in the first composite element layer.

In some embodiments, all carbon fibre reinforced composite elements in the reinforcing structure are electrically interconnected via conductive portions configured as described above. This ensures that there is a conductive path from any one carbon fibre reinforced composite element to any other carbon fibre reinforced composite element in the reinforcing structure via the conductive portions.

The interlayer may have multiple conductive portions, arranged to conduct current between two elements at more than one point. The conductance from one carbon fibre reinforced composite element to another can be increased in this way.

In some embodiments, all carbon fibre reinforced composite elements in a layer, such as in all layers, are connected as described above. In some embodiments, a conductive portion connects four carbon fibre reinforced composite elements where possible, as described above. This is not possible on an edge of a carbon fibre reinforced composite element that is not adjacent to another carbon fibre reinforced composite element in the same layer. For instance, in two adjacent stacks of three carbon fibre reinforced composite elements, a conductive portion can only be in contact with exactly four carbon fibre reinforced composite elements between the two stacks. On the free sides of each stack, a conductive portion may only provide electrical connection between two carbon fibre reinforced composite elements in adjacent layers.

In some embodiments, a thickness of the conductive portion is within 50-150% of a thickness of the non-conductive portion, such as within 80-120% of a thickness of the non-conductive portion. When the conductive portion and the non-conductive portion have approximately the same thickness, the strain in the abutting carbon fibre reinforced composite elements is minimized. In some embodiments, the thickness of the conductive portion is substantially identical, such as identical, to the thickness of the non-conductive portion.

In some embodiments, the conductive portion is attached to an anchor element extending from the conductive portion and in between the two carbon fibre reinforced composite elements that are comprised in the first composite element layer and abut the conductive portion. Such an anchor element may aid in keeping the conductive portion aligned so that during layup, the conductive portion does not shift, potentially ending up not connecting two carbon fibre reinforced composite elements in a layer as intended. In some embodiments, a thickness of the anchor element is in the range 0.05 to 2 mm, such as in the range 0.05 to 1.5 mm, such as in the range 0.05 to 1 mm, such as in the range 0.1 to 0.5 mm. This allows for controlling how close the respective carbon fibre reinforced composite elements get.

The anchor element can be made for instance of fibre reinforced composite material or metal. Dry fibre may also be used, for instance stitched to the conductive portion. The conductive portion and anchor element may also be provided by folding fibre, such as fibre mat material, to form a T-shaped element, the stem of the T providing the anchor element and the cross bar providing the conductive portion.

In some embodiments, the non-conductive portion is made at least partly of a polyester material, such as a polyester veil, such as a non-woven polyester veil. In some embodiments, the entire non-conductive portion is made of polyester, such as of a polyester veil. In some embodiments, the non-conductive portion is made at least partly of glass, such as glass fibre. In some embodiments, the non-conductive portion is made at least partly of polymeric filament. Any combination of such materials may be used for the non-conductive portion.

The non-conductive portion may be woven or non-woven.

In some embodiments, the conductive portion is made at least partly of carbon fibres. In some embodiments, the conductive portion comprises a woven carbon fibre material. In some embodiments, the conductive portion comprises a carbon fibre veil. Such materials allow conduction of lightning current while also allowing resin to pass.

In some embodiments, the conductive portion is stitched into a corresponding hole in the non-conductive portion. The conductive portion may alternatively or additionally be stapled and/or glued and/or bonded together with the non-conductive portion.

In some embodiments, the conductive portion is made of metal, such as solid metal or a metal mesh. The metal may for instance be copper or aluminium.

In some embodiments, the composite element layers and the interlayer have been bonded together in a liquid resin infusion and curing process.

In some embodiments, the reinforcing structure is part of a wind turbine blade main laminate or is a wind turbine blade main laminate.

In some embodiments, the reinforcing structure is part of a spar structure for a wind turbine blade or is a spar structure for a wind turbine blade.

In some embodiments, one or more of the carbon fibre reinforced composite elements, such as all of the carbon fibre reinforced composite elements, are at least partly or wholly made by pultrusion.

In some embodiments, a largest dimension of the conductive portion is less than 300 mm, such as less than 100 mm, such as in the range 10-60 mm, such as in the range 30-60 mm. As discussed above, the dimension must allow both sufficient conductance while not being so large that more than two carbon fibre reinforced composite elements in a layer are connected by the same conductive portion. Also, if it is too large, it will significantly, even critically, alter the resin flow, resulting in defects/infusion failure.

In some embodiments, a largest dimension of the conductive portion is equal to or less than a width of a carbon fibre reinforced composite element abutting the conductive portion, such as equal to or less than half a width of a carbon fibre reinforced composite element abutting the conductive portion.

A second aspect of the invention provides a wind turbine blade reinforced with a reinforcing structure in accordance with an embodiment of the first aspect.

The reinforcing structure may for instance be a spar cap or a main laminate or other spar structure. In some embodiments, the reinforcing structure comprises a spar beam. The reinforcing structure may for instance extend along the blade in a spanwise direction. Typically, the reinforcing structure will extend over 60-95% of a length of the blade, but in the present context this is a matter of design.

A third aspect provides a method for manufacturing a reinforcing structure in accordance with the first aspect or a wind turbine blade in accordance with the second aspect. The method comprises:
arranging at least two carbon fibre reinforced composite elements to form a first composite element layer,
providing an interlayer onto the first composite element layer, the interlayer comprising an electrically conductive portion and a non-conductive portion surrounding the conductive portion, the conductive portion abutting exactly two of the carbon fibre reinforced composite elements comprised in the first composite element layer,
arranging at least one carbon fibre reinforced composite element on the interlayer to form a second composite element layer, the first and second composite element layers sandwiching at least a part of the interlayer.

The method may further comprise adding one or more additional interlayers and composite element layers.

The method may further comprise a step of infusing liquid resin and curing the resin to bond the carbon fibre reinforced composite elements and the interlayer(s) together. This can, for example, be done using vacuum-assisted resin transfer moulding.

In some embodiments, exactly one carbon fibre reinforced composite element in the second composite element layer abuts the conductive portion.

In some embodiments, exactly two carbon fibre reinforced composite elements in the second composite element layer abut the conductive portion.

For conciseness, known steps in the process of manufacturing a wind turbine blade are not recited.

### BRIEF DESCRIPTION OF THE DRAWINGS

The invention is explained in detail below with reference to embodiments shown in the drawings.

FIG. 1 shows a wind turbine.

FIG. 2A shows a schematic view of a wind turbine blade.

FIG. 2B shows a schematic view of a cross-section of a wind turbine blade.

FIG. 3 is a perspective view of a reinforcing structure in accordance with an embodiment of the invention.

FIG. 4 is a perspective view of an interlayer for use in embodiments of the present invention.

FIGS. 5-8 show cross-sections of various embodiments of the invention.

FIGS. 9-10 illustrate interlayers used in the embodiment shown in FIG. 8.

FIG. 11 illustrates a conductive portion stitched together with a non-conductive portion of an interlayer.

### DETAILED DESCRIPTION OF SELECTED EMBODIMENTS

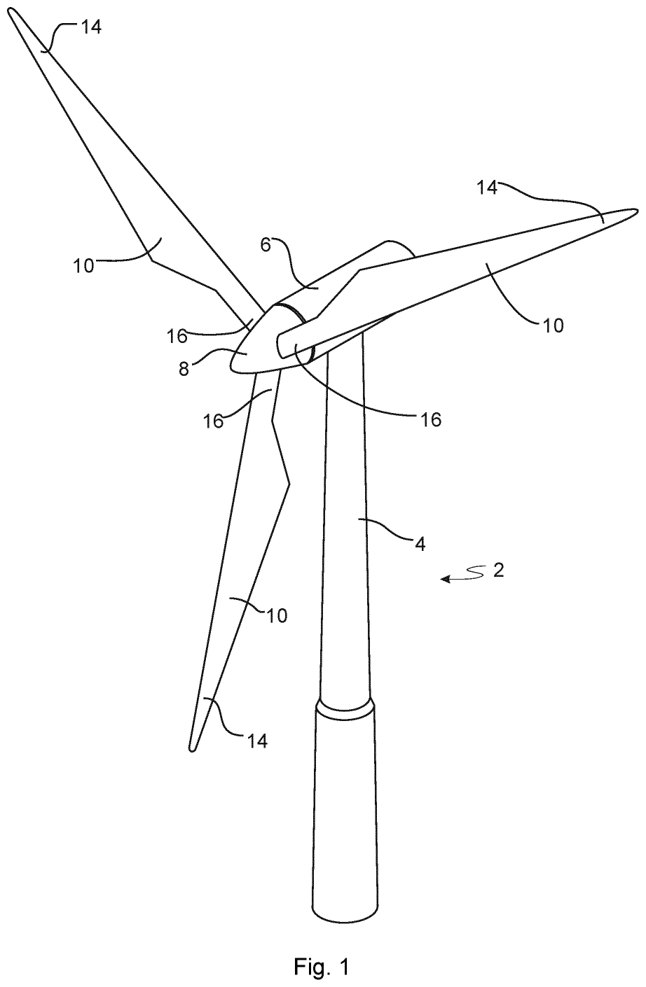

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

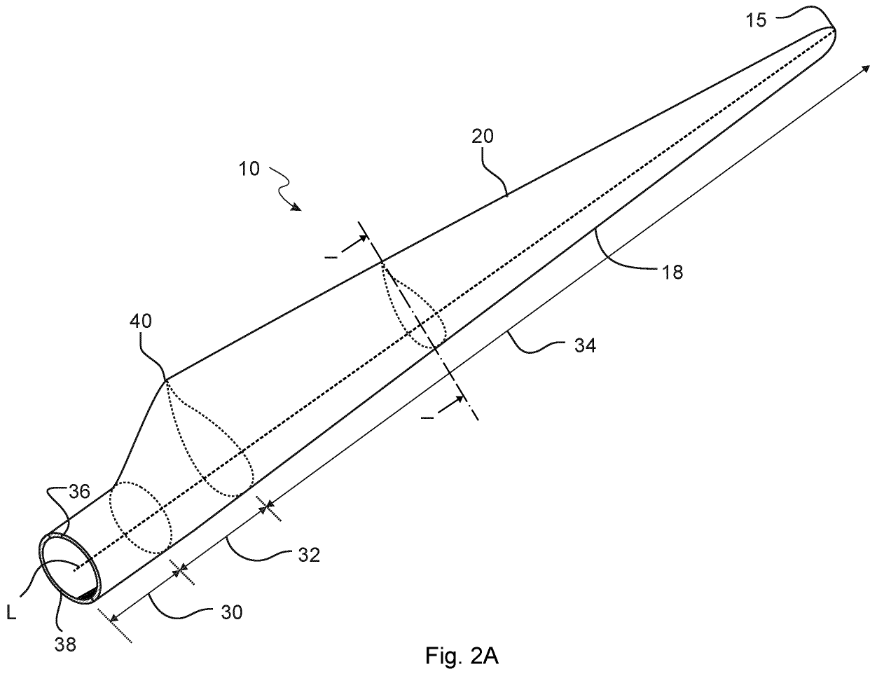

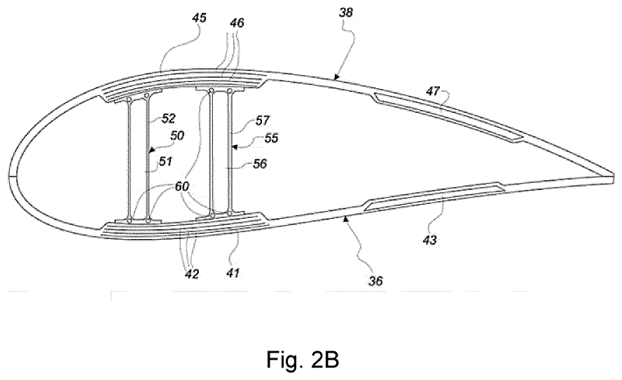

FIG. 2A shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18. The outermost point of the blade 10 is the tip end 15.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2A also illustrates the longitudinal extent L, length or longitudinal axis of the blade.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge of the blade 20.

FIG. 2B shows a schematic view of a cross-section of the blade along the line I-I shown in FIG. 2A. As previously mentioned, the blade 10 comprises a pressure side shell part 36 and a suction side shell part 38. The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 36 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

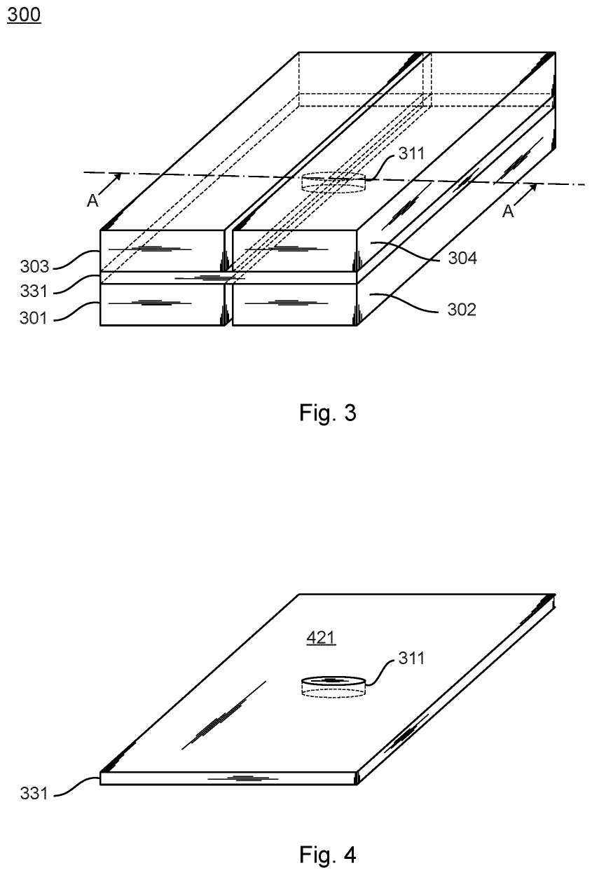

FIG. 3 illustrates a perspective view of an embodiment of a reinforcing structure in accordance with the invention. The dimensions are arbitrary in the drawings unless otherwise indicated. carbon fibre reinforced composite elements 301 and 302 form a first composite element layer of composite elements, and carbon fibre reinforced composite elements 303-304 form a second composite element layer of composite elements. The interlayer 331 separates the first composite element layer and the second composite element layer. The interlayer 331 comprises a conductive portion 311 surrounded by a non-conductive portion. The interlayer 331 is shown in more detail in FIG. 4 and further described below. Referring again to FIG. 3, the conductive portion 311 is in contact with all four carbon fibre reinforced composite elements 301-304, which means that a lightning strike connecting with any of the four carbon fibre reinforced composite elements 301-304 can propagate to all the other carbon fibre reinforced composite elements with little resistance. A lightning downconductor attached to the reinforcing structure 300 will conduct current to ground. The conductive portion 311 strongly reduces the risk of flashovers between the composite elements, which might otherwise compromise the mechanical integrity of the reinforcing structure 300, which in turn might compromise the integrity of a wind turbine blade in which the reinforcing structure is arranged.

The carbon fibre reinforced composite elements 301-304 may for instance be pultruded elements, such as planks, that are stacked to form a reinforcing structure. Stackable shapes are typically used, as they are easier to handle when laying up the reinforcing structure. However, other shapes may be used.

A conductive portion 311 made for instance of a carbon fibre material may, as discussed previously, impede the flow of liquid resin during an infusion process meant to bond all the carbon fibre reinforced composite elements and the interlayer together to form a reinforcing structure. Thus, the size of the conducting portion is such that it provides sufficient conductance between the carbon fibre reinforced composite elements 301-304, while not significantly impeding the flow of liquid resin during an infusion process.

FIG. 4 illustrates the interlayer 331 in more detail. The interlayer 331 allows liquid resin to get in between the carbon fibre reinforced composite elements 301-304 and into the interlayer 331, whereby these components are bonded into a reinforcing unit. The interlayer 331 comprises a non-conductive portion 421 and the conductive portion 311 described in relation to FIG. 3. As shown in FIGS. 3 and 4, the non-conductive portion 421 surrounds the conductive portion. In this example, the thickness of the interlayer is uniform across the layer. For planar carbon fibre reinforced composite elements, which are often used, this prevents any stress that would be present in case for instance the conductive portion 311 were thicker than the non-conductive portion 421.

The conductive portion 311 is thus embedded into the non-conductive portion 421, which may for instance be a polyester material. A polyester veil allows liquid resin to relatively easily flow between the composite element layers. As described above, the conductive portion 311 may somewhat impede flow of liquid resin, but because it extends over a relatively small area, it does not significantly affect the process of infusing liquid resin in between the carbon fibre reinforced composite elements.

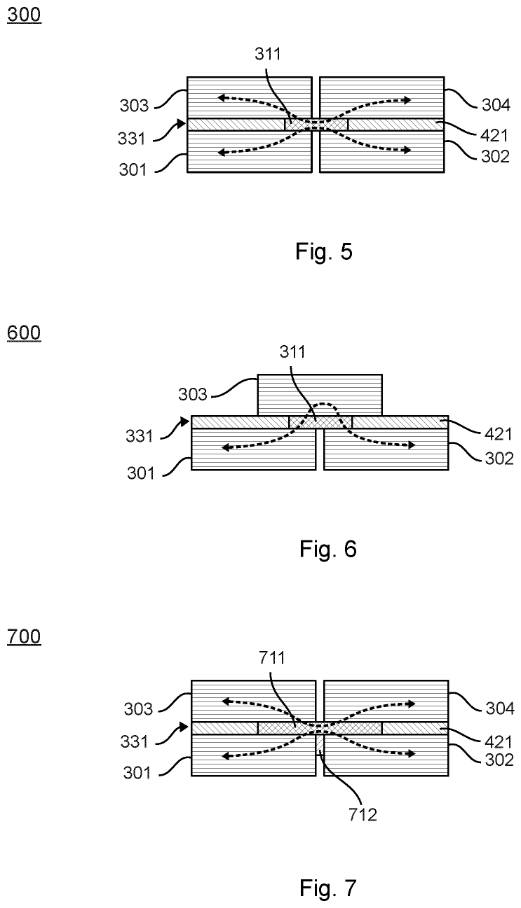

FIG. 5 illustrates the cross-section A-A indicated in FIG. 3 of the reinforcing structure 300 shown therein, i.e. across the carbon fibre reinforced composite elements 301-304 of the reinforcing structure 300 at a mid-position of the conductive portion 311.

The conductive portion 311 abuts all four carbon fibre reinforced composite elements 301-304, thereby allowing lightning current to flow between all the carbon fibre reinforced composite elements, as illustrated by the dashed lines in FIG. 5. Without the conductive portion, the conductance between the carbon fibre reinforced composite elements 301-304 would be much lower, which is what allows damaging flashovers to occur in case of a lightning strike. A single conductive portion 311 strongly reduces or eliminates the risk that a lightning strike causes a flashover between the carbon fibre reinforced composite elements that abut the conductive portion. In the present example, the width of the conductive portion is equal to half a width of the carbon fibre reinforced composite elements 301-304. As discussed previously, the conductance may be increased by increasing the size of the conductive portion, such as to the entire width of one of the carbon fibre reinforced composite elements.

For simplicity and generality, the figures do not show any resin between the carbon fibre reinforced composite elements. It is to be understood that the structure will be reinforcing once resin has been infused to bond the elements together. However, this step may take place before the reinforcing structure is applied to the part to be reinforced, or the infusion may only take place as a step that at the same time forms the part to be reinforced, bonding the carbon fibre reinforced composite elements together and bonding the carbon fibre reinforced composite elements to the part to be reinforced.

FIG. 6 illustrates an embodiment 600 which is a reinforcing structure or a part of a reinforcing structure in which only a single carbon fibre reinforced composite element 303 in the second composite element layer is adjacent to two composite elements 301-302 in the first composite element layer. For simplicity, similar reference numbers to those in FIG. 5 are used, as the corresponding elements are similar or identical. In the embodiment in FIG. 6, the conductive portion 311 abuts the two carbon fibre reinforced composite elements 301-302 in the first composite element layer and the single carbon fibre reinforced composite element 303 in the second composite element layer. As illustrated by the dashed line, the conductive portion 311 allows lightning current to flow between the three carbon fibre reinforced composite elements 301-303. Without the conductive portion 311 connecting the carbon fibre reinforced composite elements 301-303, flashovers might occur, potentially damaging one or more of the carbon fibre reinforced composite elements 301-303 and potentially compromising the structural integrity of the structure.

FIG. 7 illustrates another reinforcing structure 700 in accordance with the invention, although similar to the embodiment in FIG. 5. This example is very similar to the embodiment in FIG. 5. In the embodiment in FIG. 7, the conductive portion 711 is attached to an anchor element 712 that extends from the conductive portion 711 and in between the carbon fibre reinforced composite elements 301-302 of the first composite element layer. The width of the conductive portion 711 is equal to the width of the carbon fibre reinforced composite elements 301-304 in this example. (The width of the conductive portion 711 is unrelated to the inclusion of the anchor element 712.) When the reinforcing structure is laid up, the anchor element 712 helps maintain the conductive portion 711 in the correct place. During layup or during infusion, the interlayer 331, including the conductive portion 711, may shift relative to the carbon fibre reinforced composite elements. In case this happens, the conductive portion might not provide the desired conductive path between adjacent carbon fibre reinforced composite elements 301-304. The anchor element 712 keeps the interlayer in place, ensuring that the conductive portion provides the desired conductance between the carbon fibre reinforced composite elements 301-304.

As in FIGS. 5 and 6, the dashed lines illustrate how the conductive portion 711 provides the ability for lightning current to propagate between the carbon fibre reinforced composite elements 301-304. A downconductor connected for instance to carbon fibre reinforced composite element 301, or to a part to which the reinforcing structure 700 is electrically connected, can conduct current that attaches to any of carbon fibre reinforced composite elements 301-304 to ground with little risk of internal flashover between the carbon fibre reinforced composite elements 301-304 within the reinforcing structure 700.

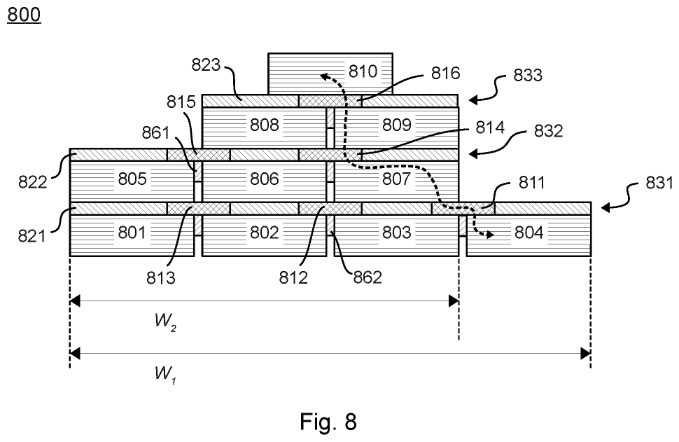

FIG. 8 illustrates a more complex reinforcing structure 800, having four composite element layers of carbon fibre reinforced composite elements 801-810. carbon fibre reinforced composite elements 801-804 make up a first composite element layer, carbon fibre reinforced composite elements 805-807 make up a second composite element layer, carbon fibre reinforced composite elements 808-809 make up a third composite element layer, and composite element 810 makes up a fourth composite element layer.

The first composite element layer is separated from the second composite element layer by interlayer 831. The second composite element layer is separated from the third composite element layer by interlayer 832. The third composite element layer is separated from the fourth composite element layer by interlayer 833.

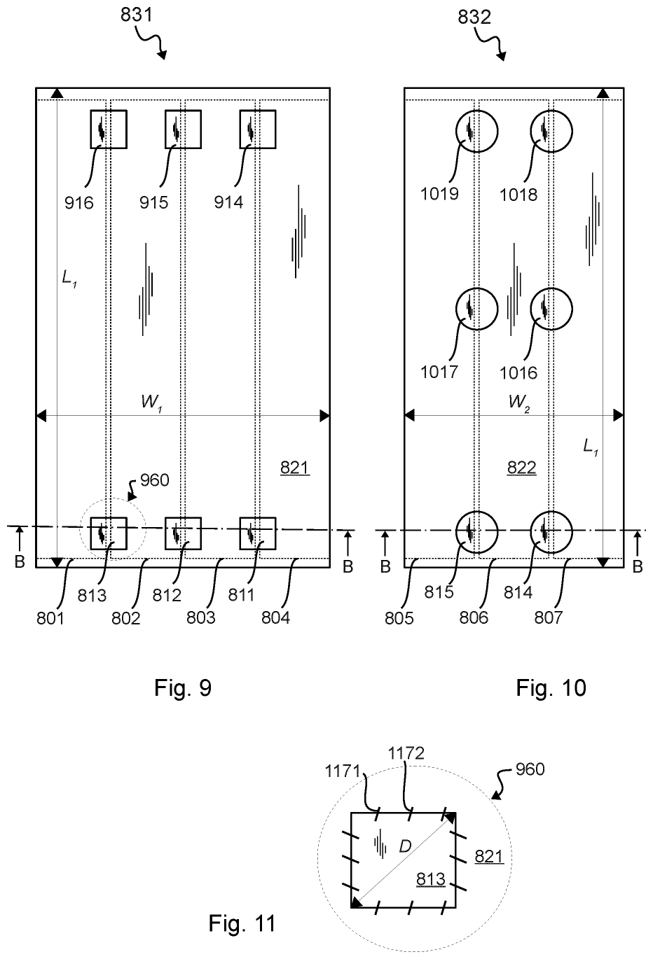

Interlayer 831 comprises a non-conductive portion 821 and conductive portions 811-813. Similarly, interlayer 832 comprises a non-conductive portion 822 and conductive portions 814-815. Interlayer 833 comprises a non-conductive portion 823 and a conductive portion 816. Widths W₁ and W₂ represent the width of the first and the second composite element layer, respectively, and will be referred to in the description of FIGS. 9 and 10.

The conductive portion 811, as an example, electrically connects carbon fibre reinforced composite elements 803 and 804 of the first composite element layer and carbon fibre reinforced composite element 807 of the second composite element layer. Similarly, conductive portion 814 electrically connects carbon fibre reinforced composite elements 806 and 807 of the second composite element layer and carbon fibre reinforced composite elements 808 and 809 of the third composite element layer. Conductive portion 816 electrically connects carbon fibre reinforced composite elements 808 and 809 of the third composite element layer and carbon fibre reinforced composite element 810 of the fourth composite element layer. As a result, lightning current can be conducted without flashover from element 804 to element 810 via conductive portions 811, 814 and 816, and via carbon fibre reinforced composite elements 807 and 809, as illustrated by the dashed line. In fact, in the embodiment in FIG. 8, any one carbon fibre reinforced composite element is electrically connected to any other carbon fibre reinforced composite element by one or more of the conductive portions 811-816, whereby a lightning strike to any one carbon fibre reinforced composite elements can propagate to a downconductor connected for instance to carbon fibre reinforced composite element 801. The conductive portions 811-816 in fact allow lightning current to be conducted along several parallel paths. For instance, lightning current can propagate from carbon fibre reinforced composite element 804 to carbon fibre reinforced composite element 801 via conductive portion 811, carbon fibre reinforced composite element 803, conductive portion 812, carbon fibre reinforced composite element 802, and conductive portion 813. Additionally, lightning current may also propagate from carbon fibre reinforced composite element 804 to carbon fibre reinforced composite element 801 via conductive portion 811, carbon fibre reinforced composite element 807, conductive portion 812, carbon fibre reinforced composite element 802, and conductive portion 813. Many other paths exist, including paths that go through the top-most conductive portion 816. Most current will flow via less resistive paths.

In the exemplary embodiment 800, each conductive portion is attached to a respective anchor element, such as anchor element 861, which assists in maintaining conductive portion 815 aligned with carbon fibre reinforced composite elements 805 and 806, ensuring a high conductance between the two carbon fibre reinforced composite elements as well as carbon fibre reinforced composite element 808. In a more complex structure such as structure 800 in FIG. 8, it is even more important that the conductive portions are maintained in the correct position relative to the carbon fibre reinforced composite elements between which the conductive portions are to provide electrical conduction.

Similarly, anchor element 862 maintains conductive portion 812 in the correct place relative to carbon fibre reinforced composite elements 802 and 803, thereby ensuring that the conductive portion 812 performs the function of allowing electrical current to be relatively easily conducted between those carbon fibre reinforced composite elements, as well elements 806-807, which also abut conductive portion 812.

The same applies to the other conducting portions and respective anchor elements shown in FIG. 8.

FIG. 9 illustrates a view of the interlayer 831 described above in relation to FIG. 8. The view in FIG. 8 corresponds to the cross-section B-B of FIG. 9. FIG. 9 represents a top view of the first composite element layer overlaid by the interlayer 831.

The interlayer has a length, L₁, which corresponds to the length of the reinforcing structure 800 and to the length of the carbon fibre reinforced composite elements. This length depends on the length of the blade. The length, L₁, may for instance be in the range 60-95 m for a blade having a total length of 100 m.

The width W₁ of the interlayer 831 corresponds to the width W₁ of the first composite element layer illustrated in FIG. 8, consisting of carbon fibre reinforced composite elements 801-804. The carbon fibre reinforced composite elements 801-804 are shown in FIG. 9 with dashed lines for reference, being covered by the interlayer 831. The conductive portions 811-813 are also shown, embedded in the non-conductive material 821 and providing a high conductance between carbon fibre reinforced composite elements 801-807.

FIG. 9 illustrates that further down the reinforcing structure, the interlayer 831 may have additional conductive portions 914-916 for conducting current between the carbon fibre reinforced composite elements 801-807. The additional conductive portions 914-916 increase the conductance between carbon fibre reinforced composite elements 801-807, further reducing the risk of flashovers between these carbon fibre reinforced composite elements.

In FIG. 9, the conductive portions are illustrated as being of a rectangular shape, which is merely an example.

Detail 960 of FIG. 9 concerns an example of how a conductive portion 813 may be connected to a non-conductive portion 821. In particular, this example shows a carbon fibre conductive portion 813 placed in a hole in a non-conductive polyester veil 821 and stitched thereto with stitches represented by references 1171-1172 in FIG. 11.

FIG. 11 also illustrates a largest dimension D of the conductive portion 813. This dimension may for instance be 100 mm.

FIG. 10 illustrates the interlayer 832 of FIG. 8, which separates the second composite element layer and the third composite element layer. FIG. 10 represents a top view of the second composite element layer overlaid by the interlayer 832. The width W₂ of the interlayer 832 corresponds to the width W₂ of the second composite element layer as illustrated in FIG. 8, consisting of carbon fibre reinforced composite elements 805-807. The carbon fibre reinforced composite elements 805-807 are shown in FIG. 10 with dashed lines for reference, being covered by the interlayer 832. The conductive portions 814-815 of interlayer 832 are also shown, embedded in the non-conductive material 822, such as a polyester veil, and providing a high conductance between carbon fibre reinforced composite elements 805-809, as can be seen from FIG. 8.

Similarly to FIG. 9, FIG. 10 illustrates that further down the reinforcing structure, an interlayer 832 may have additional conductive portions 1016-1017 and 1018-1019 for conducting current between the carbon fibre reinforced composite elements 805-809. The additional conductive portions 1016-1017 and 1018-1019 increase the conductance between carbon fibre reinforced composite elements 805-809, further reducing the risk of flashovers between these carbon fibre reinforced composite elements.

In FIG. 10, the conductive portions are illustrated as having a circular shape, which is merely an example. The different conductive portions may be individually shaped as desired.

The structure in FIG. 8 can be produced by first arranging the carbon fibre reinforced composite elements 801-804 to form a first composite element layer. Interlayer 831 is then arranged on the first composite element layer such that the conductive portions 811-813 are aligned with carbon fibre reinforced composite elements 801-804 as illustrated in FIG. 8. The anchor elements assist in ensuring that the interlayer 831 is correctly positioned relative to the first composite element layer. The anchor elements also allow the carbon fibre reinforced composite elements to be arranged with a well-defined distance, which is achieved simply by ensuring that the carbon fibre reinforced composite elements touch the anchor elements. For instance, by pushing carbon fibre reinforced composite elements 802 and 803 against anchor element 862, a well-defined space will be present between these two carbon fibre reinforced composite elements.

Next, the second composite element layer, consisting of carbon fibre reinforced composite elements 805-807, is arranged on the interlayer 831 as per FIG. 8. Interlayer 832 is then arranged on top of the second composite element layer, with the conductive portions 814-815 correctly aligned to provide conductance between the relevant carbon fibre reinforced composite elements, in particular carbon fibre reinforced composite elements 805-807. Then carbon fibre reinforced composite elements 808-809 are arranged on the interlayer 832, interlayer 833 arranged on top of carbon fibre reinforced composite elements 808-809, and finally carbon fibre reinforced composite element 810 is arranged on top of interlayer 833.

This results in the reinforcing structure 800 shown in FIG. 8.

Infusion and curing can then be performed in order to bond the carbon fibre reinforced composite elements together to form a single reinforcing unit.

The invention is not limited to the embodiments described herein and may be modified or adapted without departing from the scope of the present invention.

### LIST OF REFERENCE NUMERALS

2: wind turbine
4: tower
6: nacelle
8: hub
10: blades
14: blade tip
15: tip end
16: blade root
18: leading edge
20 trailing edge
30: root region
32: transition region
34: airfoil region
36: pressure side shell part
38: suction side shell part
40: shoulder
41: spar cap
42: fibre layers
43: sandwich core material
45: spar cap
46: fibre layers
47: sandwich core material
50: first shear web
51: sandwich core material
52: skin layers
55: second shear web
56: sandwich core material of second shear web
57: skin layers of second shear web
60: filler ropes
300: reinforcing structure
301-304: composite element
311: conductive portion of interlayer
331: interlayer
321: non-conductive portion of interlayer
421: non-conductive portion of interlayer
600: reinforcing structure
700: reinforcing structure
711: conductive portion of interlayer
712: anchor element
800: reinforcing structure
801-810: carbon fibre reinforced composite elements
811-816: conductive portions
821-823: non-conductive portions
831-833: interlayers
861-862: anchor elements
914-916: additional conductive portions
960: Detail of conductive portion with stiches
1016-1019: additional conductive portions
1171-1172: stitches
D: largest dimension of a conductive portion
L: length of wind turbine blade/longitudinal axis
L₁: length of reinforcing structure/composite elements
r: distance from hub
W₁, W₂: width of layers

1. A reinforcing structure (300), such as for reinforcing a wind turbine blade (10), comprising:
a first composite element layer comprising at least two carbon fibre reinforced composite elements (301-304, 801-810),
a second composite element layer comprising one or more carbon fibre reinforced composite elements (301-304, 801-810),
an interlayer (331, 831-833) sandwiched at least partly between the first and the second composite element layer, the interlayer comprising an electrically conductive portion (311, 811-816) and a non-conductive portion (421, 821-823) surrounding the conductive portion, the conductive portion abutting exactly two of the carbon fibre reinforced composite elements comprised in the first composite element layer.

2. A reinforcing structure in accordance with claim 1, wherein the conductive portion further abuts exactly two carbon fibre reinforced composite elements comprised in the second composite element layer.

3. A reinforcing structure in accordance with claim 1, wherein the conductive portion abuts exactly two of the carbon fibre reinforced composite elements comprised in the first composite element layer and abuts exactly one carbon fibre reinforced composite element comprised in the second composite element layer.

4. A reinforcing structure in accordance with claim 1, wherein a thickness of the conductive portion is within 50-150% of a thickness of the non-conductive portion.

5. A reinforcing structure in accordance with claim 1, wherein a thickness of the conductive portion is substantially identical, such as identical, to a thickness of the non-conductive portion.

6. A reinforcing structure in accordance with claim 1, wherein the conductive portion is attached to an anchor element extending from the conductive portion and in between the two carbon fibre reinforced composite elements that are comprised in the first composite element layer and abut the conductive portion.

7. A reinforcing structure in accordance with claim 6, wherein a thickness of the anchor element is between 0.1 and 1.5 mm.

8. A reinforcing structure in accordance with claim 1, wherein the non-conductive portion is made at least partly of a polyester material, such as a polyester veil, such as a woven or non-woven polyester veil.

9. A reinforcing structure in accordance with claim 1, wherein the conductive portion is made at least partly of carbon fibres.

10. A reinforcing structure in accordance with claim 1, wherein the conductive portion comprises a woven carbon fibre material.

11. A reinforcing structure in accordance with claim 1, wherein the conductive portion comprises a carbon fibre veil.

12. A reinforcing structure in accordance with claim 1, wherein the conductive portion is stitched or stapled or glued or bonded into a corresponding hole in the non-conductive portion.

13. A reinforcing structure in accordance with claim 1, wherein the composite element layers and the interlayer have been bonded together in a liquid resin infusion and curing process.

14. A reinforcing structure in accordance with claim 1, wherein the reinforcing structure is part of a wind turbine blade main laminate or is a wind turbine blade main laminate.

15. A reinforcing structure in accordance with claim 1, wherein the reinforcing structure is part of a spar structure for a wind turbine blade or is a spar structure for a wind turbine blade.

16. A reinforcing structure in accordance with claim 1, wherein one or more of the carbon fibre reinforced composite elements is at least partly made by pultrusion.

17. A reinforcing structure in accordance with claim 1, wherein a largest dimension of the conductive portion is less than 100 mm, such as less than 50 mm, such as in the range 30-60 mm, such as in the range 30-40 mm.

18. A reinforcing structure in accordance with claim 1, wherein a largest dimension of the conductive portion is equal to or less than a width of a carbon fibre reinforced composite element abutting the conductive portion, such as equal to or less than half a width of a carbon fibre reinforced composite element abutting the conductive portion.

19. A wind turbine blade reinforced with a reinforcing structure in accordance with claim 1.

20. A method for manufacturing a reinforcing structure or a wind turbine blade in accordance with claim 19, the method comprising:
arranging at least two carbon fibre reinforced composite elements (301-304, 801-810) to form a first composite element layer,
providing an interlayer onto the first composite element layer (331, 831-833), the interlayer comprising an electrically conductive portion (311, 811-816) and a non-conductive portion (421, 821-823) surrounding the conductive portion, the conductive portion abutting exactly two of the carbon fibre reinforced composite elements comprised in the first composite element layer,
arranging at least one carbon fibre reinforced composite element (301-304, 801-810) on the interlayer to form a second composite element layer, the first and second composite element layers sandwiching at least a part of the interlayer.

21. A method in accordance with claim 20, wherein exactly one carbon fibre reinforced composite element in the second composite element layer abuts the conductive portion.

22. A method in accordance with claim 20, wherein exactly two carbon fibre reinforced composite elements in the second composite element layer abut the conductive portion.
